(19) United States
(12) Patent Application Publication
(10) Pub. No.: US 2025/0372326 A1
(43) Pub. Date: Dec. 4, 2025

(54) RELAY

(71) Applicant: FCL Components Limited, Tokyo (JP)

(72) Inventors: Satoshi Moriyama, Tokyo (JP); Yoichi Hasegawa, Tokyo (JP); Hiroaki Kohinata, Tokyo (JP); Masahide Mochizuki, Tokyo (JP)

(21) Appl. No.: 19/092,709

(22) Filed: Mar. 27, 2025

(30) Foreign Application Priority Data
May 30, 2024 (JP) 2024-088122

(51) Int. Cl. H01H 50/14

(52) U.S. Cl. CPC H01H 50/14

(57) ABSTRACT

A relay having improved mechanical reliability of a movable terminal having rolled marks and an extended life span is provided. The relay has a base block and a movable terminal positioned in the base block and having rolled marks. The movable terminal has an insertion part inserted into the base block, a movable contact elastically displaceable in a direction substantially perpendicular to a direction of the rolled marks with the insertion part as a fulcrum, and a plurality of frustums formed on the insertion part and abutting against the base block.

### CROSS-REFERENCE TO RELATED APPLICATIONS

This application is based upon and claims the benefit of priority of the prior Japanese Patent Application No. 2024-088122 filed on May 30, 2024, the entire contents of which are incorporated herein by reference.

### TECHNICAL FIELD

A certain aspect of the embodiments is related to a relay.

### BACKGROUND

A relay (electromagnetic relay) has an electromagnet, an armature configured to be movable relative to the electromagnet by magnetic force, and a contact element which opens and closes in conjunction with the armature.

A relay is known having a fixed terminal and a movable terminal as a contact element, wherein the fixed terminal has a fixed contact and is fixed to a base block, etc., and the movable terminal has a movable contact facing the fixed contact across a gap and elastically deforms with the base block, etc., as a fulcrum.

### RELATED ART

[Patent Literature 1] JP 2008-270196 A

A rolling process of a conductive metal material is one of the processes for producing a movable terminal of a relay. In this process, the produced movable terminal has multiple fine streaks (also referred to as roll marks) extending in the direction of a mill roll during the rolling process. Since the crystal structure inside the rolled product extends in the direction of the roll marks, cracking is unlikely to occur when a bending process is performed in a direction perpendicular to the roll marks, and warping is unlikely to occur when a cutting process is performed along the roll marks.

When the movable terminal is manufactured by a rolling process, the direction of the roll marks is often perpendicular to the elastic displacement direction of the movable contact. In this case, the direction of the roll marks coincides with the direction in which a hem or bottom edge of the movable terminal press-fitted into the base block extends. Therefore, the movable terminal may easily break as the movable terminal repeatedly deforms elastically, with the bottom edge acting as a fulcrum.

One way to solve this problem is to change the direction of the roll marks of the movable terminal. However, taking into consideration the shape processing required to satisfy the material characteristics and the cost per unit, which is determined by how many movable terminals can be produced from a given area of material, it is difficult to change the direction of the roll marks.

Therefore, there is a need for a relay having a long life by improving the mechanical reliability of the movable terminal having roll marks.

### SUMMARY

One aspect of the present disclosure is a relay comprising a base block, and a movable terminal positioned in the base block and having roll marks, wherein the movable terminal has: an insertion part inserted into the base block; a movable contact elastically displaceable in a direction generally perpendicular to a direction of the roll marks with the insertion part as a fulcrum; and a plurality of frustums formed on the insertion part and configured to contact the base block.

Another aspect of the present disclosure is a relay comprising a base block, and a movable terminal positioned in the base block and having roll marks, wherein the movable terminal has: an insertion part inserted into the base block; a movable contact elastically displaceable in a direction generally perpendicular to a direction of the roll marks with the insertion part as a fulcrum; and an elongated frustum formed on the insertion part and configured to contact the base block, and wherein an extending direction of a portion of a bottom edge of the elongated frustum along a longitudinal direction of the elongated frustum is inclined at a non-zero angle relative to the direction of the roll marks.

### BRIEF DESCRIPTION OF DRAWINGS

FIG. 1 is an exploded perspective view of a relay according to an embodiment;

FIG. 2 is a view showing a first example of a movable spring piece;

FIG. 3 is a cross-sectional view along an A-A line of FIG. 2;

FIG. 4 is a view showing a movable spring piece according to a comparative example;

FIG. 5 is a view showing a second example of a movable spring piece;

FIG. 6 is a cross-sectional view along a B-B line of FIG. 5;

FIG. 7 is a view showing a third example of a movable spring piece;

FIG. 8 is a view of the movable spring piece of FIG. 7 as viewed in a direction of an arrow C;

FIG. 9 is a view showing a forth example of a movable spring piece;

FIG. 10 is a partially enlarged view of FIG. 9;

FIG. 11 is view showing a fifth example of a movable spring piece;

FIG. 12 is a view of the movable spring piece of FIG. 11 as viewed in a direction of an arrow D;

FIG. 13 is a view showing a sixth example of a movable spring piece;

FIG. 14 is a cross-sectional view along an E-E line of FIG. 13; and

FIG. 15 is a partially enlarged view of FIG. 13.

### DESCRIPTION OF EMBODIMENTS

According to the present disclosure, the length of the portion of the bottom edge of the movable terminal press-fitted into the base block, which coincides with the direction of the roll marks, can be shortened. Therefore, the movable terminal is less likely to be damaged due to repeated movements, the mechanical reliability of the movable terminal is improved, and the life of the relay is extended.

Hereinafter, a description will be given of an embodiment of the present disclosure with reference to the drawings.

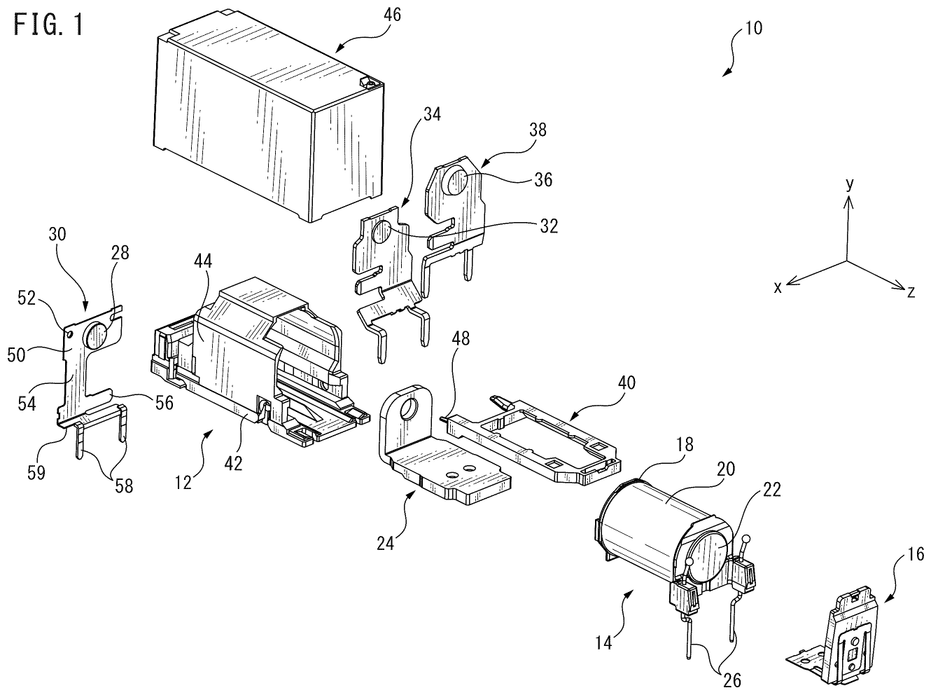

FIG. 1 is an exploded perspective view of a relay 10 according to an embodiment. For example, the relay 10 is used in home appliances such as refrigerators and washing machines, and in-vehicle products installed in automobiles. The relay 10 has a base block 12, an electromagnet block 14 fixed to the base block 12, and an armature 16 positioned on one end of the electromagnet block 14 and attracted by a magnetic force generated by the operation of the electromagnet block 14. The electromagnet block 14 has an insulating bobbin 18, a coil 20 wound around the bobbin 18, an iron core 22 positioned in the bobbin 18, a substantially L-shaped yoke 24 connected to one end of the iron core 22 and forming a magnetic circuit in cooperation with the iron core 22, and two coil terminals 26, one end of which is connected to the coil 20 and the other end of which is connected to an external power source (not shown).

The relay 10 has a movable terminal (movable spring piece) 30 having a movable contact 28 configured to move in a direction toward and away from the iron core 22 in response to the movement of the armature 16, and a fixed terminal having a fixed contact positioned opposed to the movable contact 28 with a certain gap therebetween. In this embodiment, the fixed terminal includes a first fixed terminal (break terminal) 34 having a fixed normally closed contact (break contact) 32, and a second fixed terminal (make terminal) 38 having a fixed normally open contact (make contact) 36. The movable contact 26 contacts the break contact 32 when the electromagnet block 14 is OFF, and contacts the make contact 36 when the electromagnet block 14 is ON. The relay 10 also has a card 40, which is an example of a sliding member, having one end connected to the armature 16 and the other end abutting the movable terminal 30, wherein the sliding member is configured to move linearly in the longitudinal direction of the electromagnet block 14 in conjunction with the armature 16 to elastically displace the movable terminal 30.

The base block 12 has a substantially flat base 42 and a housing 44 configured to contain the electromagnet block 14. The relay 10 also has a cover 46 configured to fit into the base block 12 and cooperate with the base block 12 to contain the above-mentioned components. Among the components of the relay 10, the base block 12, the bobbin 18 and the cover 46 are made of an electrically insulating resin material and can be molded by, for example, injection molding. The relay 10 may be assembled automatically using an assembly machine, etc., or may be assembled manually.

For convenience, in this embodiment, a direction parallel to an axial direction of the iron core 22 is referred to as a z-direction, a direction perpendicular to the z-direction and along a direction of roll marks when manufacturing the movable terminal 30 described later is referred to as an x-direction (width direction), and a direction perpendicular to both the x-direction and the z-direction is referred to as a y-direction.

### First Example

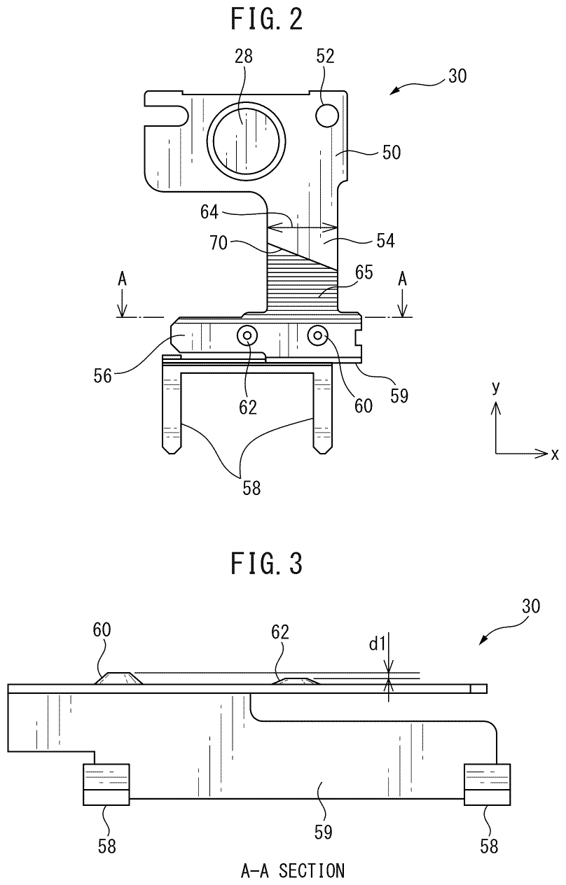

FIG. 2 is a view showing the movable terminal 30 according to a first example, and FIG. 3 is a cross-sectional view along an A-A line in FIG. 2. The movable terminal 30 is a leaf spring-shaped member formed by rolling a conductive material such as phosphor bronze for springs and then punching it into a predetermined shape by a pressing process, etc. The movable terminal 30 has fine streaks, i.e., roll marks 65, extending in a roll direction 64 during the rolling process.

The movable terminal 30 has a substantially U-shape in a plan view and includes a tab 50 having a movable contact 28, an insertion part 56 to be inserted into the base block 12, a connection part 54 connecting the tab 50 and the insertion part 56, a step 59 extending substantially perpendicularly from the insertion part 56, and at least one (two in the example of FIG. 2) terminal 58 extending from the step 59 to the opposite side to the movable contact 28. When the movable terminal 30 is press-fitted into the base block 12 and positioned and fixed, the terminal 58 extends from the lower surface of the base block 12 and is electrically connected to an electronic board (not shown), etc.

The tab 50 has a hole 52 with which a protrusion 48 of the card 40 shown in FIG. 1 can be engaged, and is elastically displaced in association with the movement of the card 40. More specifically, the tab 50 and the connecting part 54 are elastically displaced in the z-direction with the insertion part 56 press-fitted into the base block 12 as a fulcrum. The connection part 54 may be bent somewhat along an angled bend line 70 with respect to the x- or y-direction in order to improve contactability between the contacts by causing a twisting motion in the tab 50 during the elastic displacement.

The movable terminal 30 has the roll marks 65 (only a portion of which is shown in FIG. 2) on its entire surface in the direction generally perpendicular to the displacement direction (the x-direction in FIG. 2) of the tab 50. Therefore, due to repeated movement of the card 40, the movable terminal 30 may be damaged, particularly near a boundary between the insertion part 56 and the connection part 54.

In this example, the length of the portion of the bottom edge of the movable terminal 30 press-fitted into the base block 12, which coincides with the direction 64 of the roll marks 65, is shortened as much as possible, so that the movable terminal 30 is less likely to break or be damaged. Specifically, the insertion part 56 has a plurality of frustums (two truncated cones 60 and 62 in FIG. 2), as a press-in part which abuts against the base block 12 when inserted into the base block 12. Since the bottom edge of the truncated cone has a circular shape, the portion of the bottom edge along the direction 64 where stress is likely to concentrate is essentially a point. In other words, the bottom edge does not have a portion which extends over a certain length along the direction 64. Therefore, the movable terminal 30 is less likely to break along the roll marks 65 with the truncated cones 60 and 62, which are the abutting parts with the base block 12, as fulcrums.

As shown in FIG. 3, the heights of the plurality of truncated cones 60, 62 are different from each other. In the example of FIG. 3, the height of the truncated cone 62 which first comes into contact with the base block 12 when the insertion part 56 is inserted into the base block 12 is lower than the height of the truncated cone 60 by d1. By forming the truncated cones 60, 62 in such a shape, the press-fitting operation of the movable terminal 30 can be performed stably. The range of d1 is, for example, 0.01 mm to 0.25 mm. In addition, by arranging the plurality of truncated cones 60, 62 so that their centers are aligned in the insertion direction of the insertion part 56, which is the − (minus) x-direction in FIG. 2, accurate positioning and stable holding of the movable terminal 30 can be achieved.

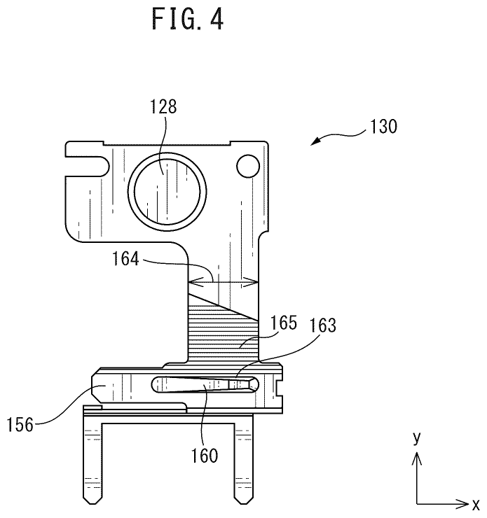

FIG. 4 is a schematic view of a movable terminal 130 according to a comparative example. Similarly to the movable terminal 30 according to the first example, the movable terminal 130 has a generally U-shape in a plan view and has a movable contact 128 and an insertion part 156 inserted into the base block. The insertion part 156 has an elongated truncated pyramid 160 extending along a direction 164 of the roll marks 165 as a press-fit part which abuts against the base block.

Since the truncated pyramid 160 extends along the direction 164 of the roll marks 165, the bottom edge of the truncated pyramid 160 has a relatively long portion 163 extending in line with the direction 164. Therefore, when the movable terminal 130 is repeatedly elastically displaced, the portion 163 extending parallel to the direction 164 becomes a fulcrum, and there is a possibility that the movable terminal 130 may break or be damaged. However, in the first example, the portion of the bottom edge of each truncated cone along the direction 64 of the rolled marks 65 is substantially a point, so that the movable terminal 30 is much less likely to break than the comparative example. As a result, in this example, the mechanical reliability of the movable terminal 30 is improved, and the life of the relay can be extended.

### Second Example

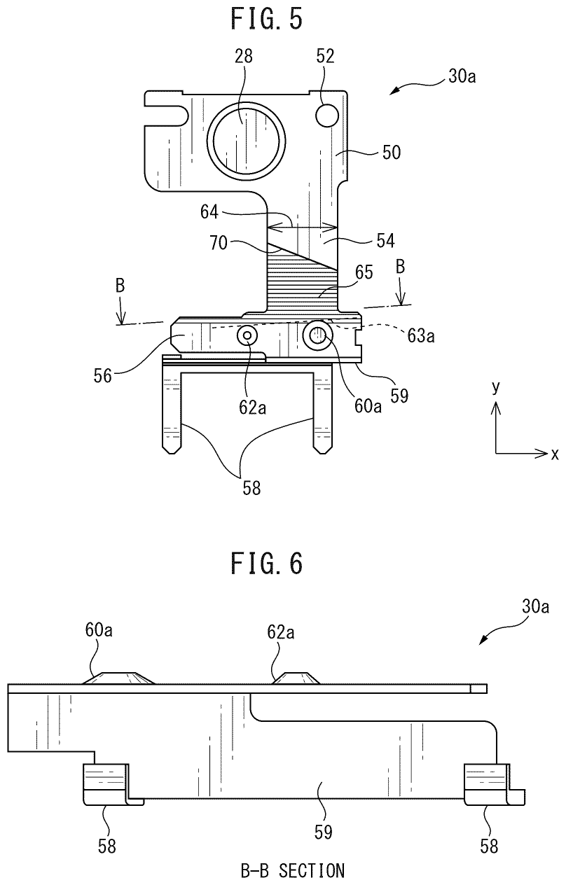

FIG. 5 is a view showing a movable terminal 30a according to a second example, and FIG. 6 is a cross-sectional view along a B-B line in FIG. 5. In the second example, only the parts which differ from the first example will be described, and the parts which are the same as those in the first example will be given the same reference numerals as in the first example, and detailed descriptions thereof will be omitted.

The insertion part 56 of the movable terminal 30a has a plurality of frustums (two truncated cones 60a and 62a in the example of FIG. 5), as a press-fitted part abutting against the base block 12 when inserted into the base block 12. Similarly to the first example, the portion of the bottom edge of each truncated cone extending along the direction 64 of the roll marks 65 is substantially a point, so that the movable terminal 30a is less likely to break with the truncated cones 60a and 62a, abutting against the base block 12, as fulcrums.

In the second example, the two truncated cones 60a, 62a are arranged so that their centers are aligned in the direction 64, and the sizes of the bottom edges of the two truncated cones are different from each other. Therefore, even when the centers of the truncated cones 60a, 62a are arranged in a direction parallel to the direction 64, a direction of a tangent line 63a common to the bottom edges of the truncated cones is different from the direction 64, so that the movable terminal 30a is even more difficult to break. As shown in FIG. 6, the heights of the truncated cones 60a, 62a are the same, but they may be different as in a third example described later. When the heights are the same, the manufacture of the movable terminal becomes somewhat easier.

### Third Example

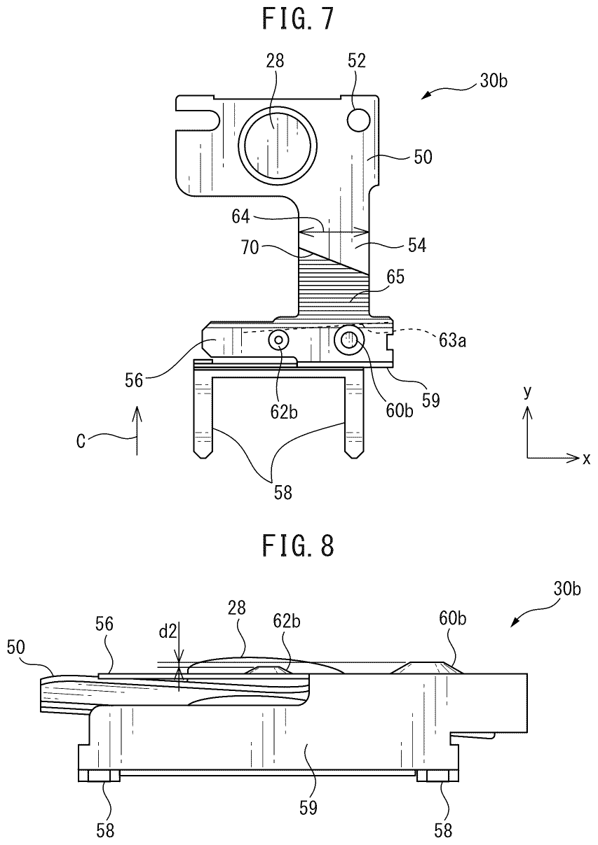

FIG. 7 is a view showing a movable terminal 30b according to a third example, and FIG. 8 is a view showing the movable terminal 30b of FIG. 7 as viewed in a direction of an arrow C. In the third example, only the parts which differ from the first example will be described, and the parts which are the same as those in the first example will be given the same reference numerals as in the first example, and detailed descriptions thereof will be omitted.

In the third example, similarly to the second example, two truncated cones 60b, 62b as a press-fitted part are arranged so that their centers are aligned in the direction 64 of the roll marks 65, and the sizes of the bottom edges of the two truncated cones are different from each other. The direction of the tangent line 63a common to the bottom edges of the truncated cones is different from the direction 64 of the roll marks 65, so that the movable terminal 30b is even difficult to break. Also, as shown in FIG. 8, the height of the truncated cone 62b, which first comes into contact with the base block 12 when the insert part 56 is inserted into the base block 12, is lower than the truncated cone 60b by d2. When the truncated cones 60b, 62b are formed in this way, the press-fitting operation of the movable terminal 30b can be performed stably. The range of d2 is, for example, 0.1 mm to 0.5 mm.

### Fourth Example

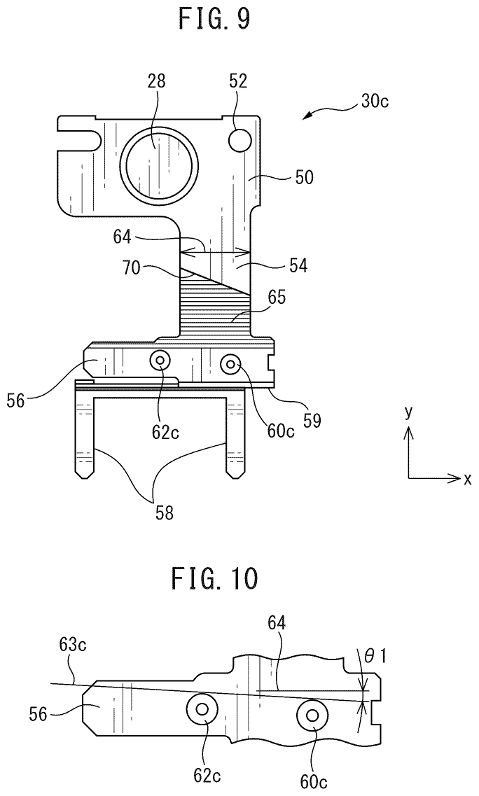

FIG. 9 is a view showing a movable terminal 30c according to a fourth example, and FIG. 10 is a partially enlarged view of the insertion part 56 of the movable terminal 30c of FIG. 9. In the fourth example, only the parts which differ from the first example will be described, and the parts which are the same as those in the first example will be given the same reference numerals as in the first example, and detailed descriptions thereof will be omitted.

The insertion part 56 of the movable terminal 30c according to the fourth embodiment has two truncated cones 60c, 62c having the same diameter at the bottom edge, similarly to the first example. However, the truncated cones 60c, 62c are not arranged so that their centers are aligned along the insertion direction of the insertion part 56, i.e., the − (minus) x-direction in FIG. 9, but are arranged so that they are aligned along a direction somewhat inclined from the direction 64. More specifically, the direction of the tangent line 63c common to the bottom edges of the truncated cones is inclined at a non-zero angle θ1 with respect to the direction 64 of the roll marks 65. Therefore, in the fourth example, the movable terminal 30c is less likely to break due to the same function as in the second example. The range of θ1 is, for example, 1° to 6.5°. The heights of the truncated cones 60c, 62c may be the same or may be different from each other.

### Fifth Example

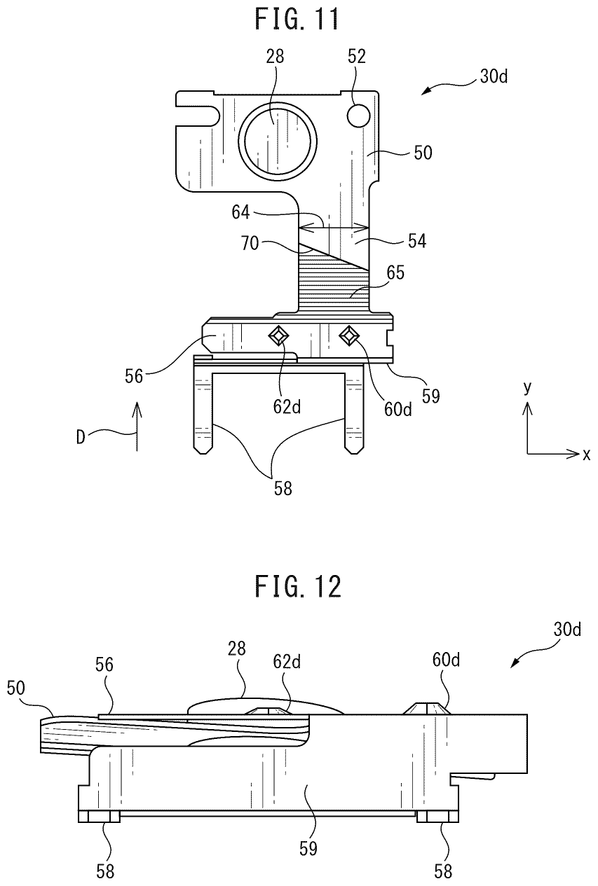

FIG. 11 is a view showing a movable terminal 30d according to a fifth example, and FIG. 12 is a view showing the movable terminal 30d of FIG. 11 as viewed in a direction of an arrow D. In the fifth example, only the parts which differ from the first example will be described, and the parts which are the same as those in the first example will be given the same reference numerals as in the first example, and detailed descriptions thereof will be omitted.

The insertion part 56 of the movable terminal 30d according to the fifth example has two truncated pyramids (quadrangular truncated pyramids 60d and 62d in FIG. 11) having the same size. When the truncated pyramid is used as the press-fitted part in this manner, it is preferable that the direction of each side of each truncated pyramid does not coincide with the direction 64 of the roll marks 65. In this way, the portion of the bottom edge of the truncated pyramid along the direction 64 is essentially a point, so that the possibility of the movable terminal 30d breaking at each of the truncated pyramids 60d and 62d as fulcrums, which are the contact points with the base block 12, can be reduced, as in the above-mentioned examples.

The heights of the pyramids 60d, 62d may be different from each other as shown in FIG. 12, or may be the same. Similarly to the above-mentioned truncated cones, the truncated pyramids 60d, 62d may be arranged so that their centers are aligned in the direction 64, or so that their centers are aligned in a direction inclined relative to the direction 64.

### Sixth Example

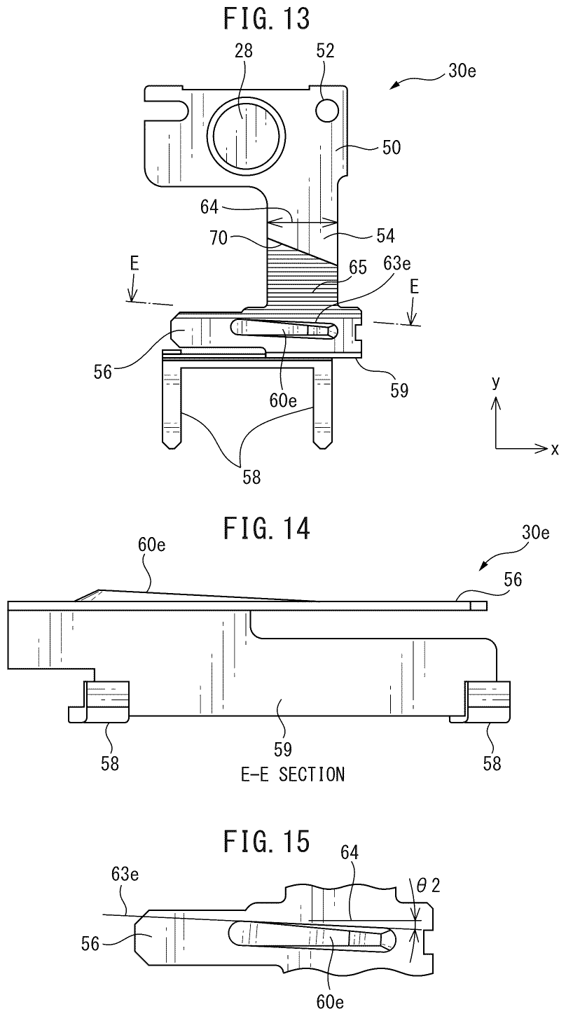

FIG. 13 is a view showing a movable terminal 30e according to a sixth example, FIG. 14 is a cross-sectional view along an E-E line in FIG. 13, and FIG. 15 a partially enlarged view of a press-fitted part 60e of the movable terminal 30e of FIG. 13. In the sixth example, only the parts which differ from the first example will be described, and the parts which are the same as those in the first example will be given the same reference numerals as in the first example, and detailed descriptions thereof will be omitted.

The insertion part 56 of the movable terminal 30e has an elongated truncated pyramid extending in one direction, similar to the press-fitted part 160 of the comparative example shown in FIG. 4. However, the longitudinal direction of the elongated truncated pyramid does not coincide with the direction 64 of the roll marks 65. Specifically, the direction in which a portion 63e along the longitudinal direction of the bottom edge of the truncated pyramid 60e extends is inclined at a non-zero angle θ2 relative to the direction 64. Therefore, also in the sixth example, the movable terminal 30e is less likely to break due to the same effect as in the above-mentioned examples. The range of θ2 is, for example, 1° to 10°.

In the above explanation, the relay having a so-called 1c contact structure, which has the break terminal 34 with the fixed contact 32, has been described, but the application of the present disclosure is not limited to this. For example, the present disclosure can be similarly applied to a relay having a so-called 1a contact structure, which has a backstop or the like without a fixed contact instead of the break terminal.

What is claimed is:

1. A relay comprising a base block, and a movable terminal positioned in the base block and having roll marks,
wherein the movable terminal has:
an insertion part inserted into the base block;
a movable contact elastically displaceable in a direction generally perpendicular to a direction of the roll marks with the insertion part as a fulcrum; and
a plurality of frustums formed on the insertion part and configured to contact the base block.

2. The relay according to claim 1, wherein each of the plurality of frustums is a truncated cone.

3. The relay according to claim 1, wherein the plurality of frustums are arranged so that a direction of a tangent line common to bottom edges of the frustums is inclined at a non-zero angle relative to the direction of the roll marks.

4. The relay according to claim 1, wherein each of the plurality of frustums is a truncated pyramid.

5. The relay according to claim 1, wherein the plurality of frustums have different heights.

6. The relay according to claim 1, wherein the plurality of frustums are different in size.

7. A relay comprising a base block, and a movable terminal positioned in the base block and having roll marks,
wherein the movable terminal has:
an insertion part inserted into the base block;
a movable contact elastically displaceable in a direction generally perpendicular to a direction of the roll marks with the insertion part as a fulcrum; and
an elongated frustum formed on the insertion part and configured to contact the base block, and
wherein an extending direction of a portion of a bottom edge of the elongated frustum along a longitudinal direction of the elongated frustum is inclined at a non-zero angle relative to the direction of the roll marks.
